(19) United States
(12) Patent Application Publication
(10) Pub. No.: US 2009/0083668 A1
(43) Pub. Date: Mar. 26, 2009

(54) IMAGING APPARATUS AND METHOD FOR CONTROLLING THE SAME

(75) Inventors: Toyokazu Aizawa, Sagamihara-shi (JP); Shiro Nagaoka, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/208,766

(22) Filed: Sep. 11, 2008

(30) Foreign Application Priority Data
Sep. 21, 2007 (JP) 2007-245065

(51) Int. Cl. G06F 3/048

(52) U.S. Cl. 715/838

(57) ABSTRACT

According to one embodiment, an imaging apparatus according to one embodiment of the invention has an image taking part, an image data processor, a display part, a storage part, and a controller. The controller displays a curved band-like image and a plurality of storage media mark images, and arranges and simultaneously displays a plurality of folder icon images on the curved band-like image. A plurality of thumbnails in a folder represented by a folder icon image, which is positioned at a center position among the plurality of folder icon images, are displayed. A cursor is controlled to be moved to an arbitrary position which is any position including any position of the plurality of thumbnails, a position of the center folder icon image, and any position of the plurality of storage media mark images, in response to the operation input, whereby a selection state can be obtained.

### CROSS-REFERENCE TO RELATED APPLICATIONS

This application is based upon and claims the benefit of priority from Japanese Patent Application No. 2007-245065, filed Sep. 21, 2007, the entire contents of which are incorporated herein by reference.

### BACKGROUND

1. Field

One embodiment of the invention relates to an imaging apparatus and a method for controlling the same. Particularly, the invention is applicable to and effective for an imaging apparatus which can store a moving image and still image in a plurality of storage media and manages a plurality of folders and thumbnails.

2. Description of the Related Art

An imaging apparatus has a function for managing a plurality of folders (also referred to as albums) and a plurality of thumbnails in each of the folders (for example, Jpn. Pat. Appln. KOKAI Publication Nos. 2006-191300 and 2006-148874). In the management function, the plurality of thumbnails and the folder number are simultaneously displayed in a display part so as to clarify the folder in which the plurality of thumbnails are stored.

Meanwhile, recently, the storage capacity of a storage medium is increased due to the technical development of the storage medium. In addition, the imaging apparatus which can mount a plurality of storage media (for example, the imaging apparatus which has a built-in hard disk and to/from which a memory card can be inserted or removed) is developed.

In the above imaging apparatuses, there is a problem that it is difficult to find the folder being opened, the presence of other folders, and the storage medium being accessed when the plurality of thumbnails are displayed in the display part.

Further, the operability when the intended folder is selected from various folders in an arbitrary storage medium is desired to be improved.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIGS. 1A and 1B are explanatory views showing an outline of an imaging apparatus to which this invention is applied;

FIG. 2 is a diagram showing the electrical function blocks of the imaging apparatus in FIG. 1;

FIG. 3 is a diagram showing the function block of a controller in FIG. 2;

FIG. 4 is an explanatory view showing an operation means when starting the characteristic operation of this invention;

FIG. 5 is a view showing an example of a list display, which is a part of the characteristic of this invention;

FIGS. 6A and 6B are explanatory views for explaining the change of the list display shown in FIG. 5 and the operation with the change;

FIGS. 7A and 7B are explanatory views for explaining the change of the list display shown in FIG. 5 and the operation with the change;

FIGS. 8A and 8B are explanatory views for explaining the change of the list display shown in FIG. 5 and the operation with the change;

FIGS. 9A and 9B are explanatory views for explaining the change of the list display shown in FIG. 5 and the operation with the change;

FIG. 10 is another explanatory view for explaining the change of the list display shown in FIG. 5;

FIG. 11 is an explanatory view for explaining the change of the list display shown in FIG. 5;

FIG. 12 is another explanatory view for explaining the change of the list display shown in FIG. 5; and

FIG. 13 is an explanatory view for explaining the change of the list display shown in FIG. 5.

### DETAILED DESCRIPTION

Various embodiments according to the invention will be described hereinafter with reference to the accompanying drawings.

One embodiment of this invention provides an imaging apparatus which displays a relationship among a plurality of storage media, a plurality of folders, and a plurality of thumbnails in an easily understandable manner, realizes the selection of an arbitrary folder in a simple manner, and realizes the improvement of the operability, and a method for controlling the imaging device.

In one aspect of this invention, the imaging apparatus has an image data processor for processing obtained image data, which has been obtained in an image taking part, a display part for displaying image data for display which has been processed in the image data processor, a storage part for storing image data for storage which has been processed in the image data processor, and a controller for controlling the image taking part, the image data processor, the display part, and the storage part.

The controller displays a band-like image in the display part, and displays a plurality of storage media mark images near the band-like image. The controller has a display parts selector for arranging and simultaneously displaying, on the band-like image, a plurality of folder icon images in a plurality of folders contained in a storage medium, which is designated by selecting the plurality of storage media mark images. In addition, the controller has a thumbnail controller for displaying, in an outside region on a right side of the band-like image, a plurality of thumbnails in a folder represented by the folder icon image, which is positioned at a center position among a plurality of the folder icon images. Further, the controller has a cursor position controller for controlling the cursor to move to an arbitrary position, which is any position, including any position of the plurality of thumbnails, a position of the center folder icon image among the plurality of folder icon images, and any position of the plurality of storage media mark images, in response to the operation input, whereby a selection state can be obtained. Note that in this specification, imaging and taking a moving image or a still image have the same meaning.

According to the above means, the plurality of storage media mark images, the plurality of folder icon images, and the plurality of thumbnails which are related to one another are simultaneously displayed in the display part, whereby the relationship is clarified. In addition, the cursor can be moved to any position, whereby excellent operability for selecting a storage medium and a folder is provided.

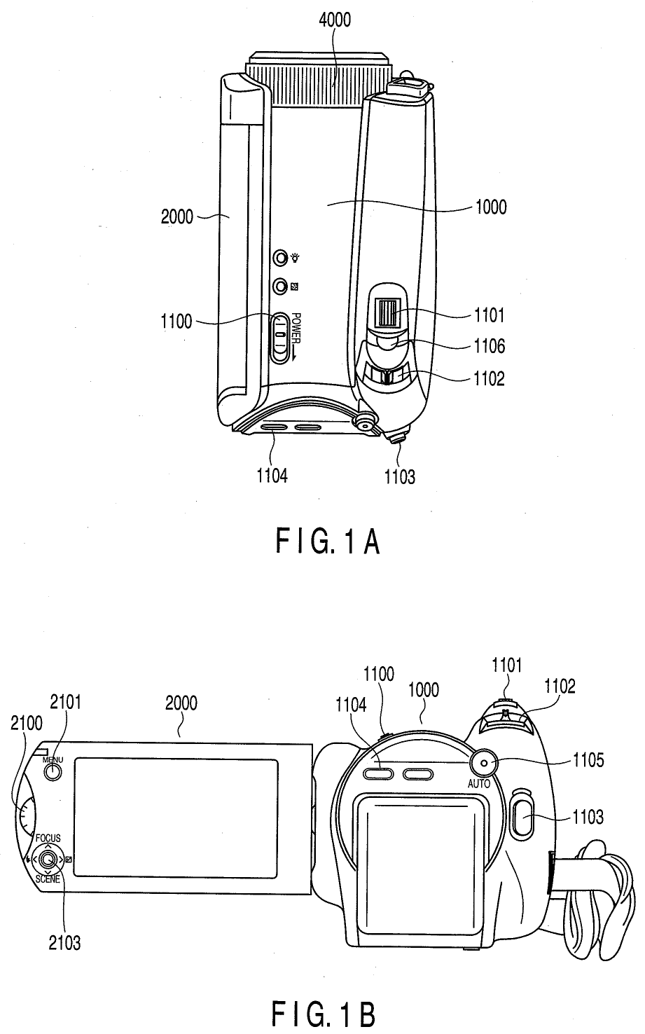

Hereinafter, the embodiment of this invention is explained more specifically with reference to the drawings. FIG. 1 shows an outline of a hi-vision video camera, which is an imaging apparatus to which this invention is applied. The hi-vision video camera can take a moving image and a still image.

FIG. 1A is an overhead view of the hi-vision video camera. FIG. 1B shows the hi-vision video camera as viewed from the back side. As shown in FIGS. 1A and 1B, the hi-vision video camera is provided with an imaging apparatus body 1000, a display panel 2000, and a lens part 4000.

The imaging apparatus body 1000 is provided with a power switch 1100, a zoom lever 1101, an imaging/reproducing switching button 1102, an imaging button 1103, a chapter button 1104, and an auto setting button 1105.

The power switch 1100 is used for switching a state of the power source of the hi-vision video camera. The zoom lever 1101 is used for adjusting a focal length of the lens part 4000. The imaging/reproducing switching button 1102 is used for switching an operation mode of the hi-vision video camera to a taking mode for taking images or a reproducing mode for reproducing imaging data stored in the apparatus. The imaging button 1103 is used for recording the images when the operation mode of the hi-vision video camera is in the taking mode. The chapter button 1104 is used for setting unititions in the imaging data. The auto setting button 1105 is used for automatically performing various kinds of settings, such as sensitivity and brightness, when the images are taken. Reference numeral 1106 is a button for taking a still image.

The display panel 2000, which is a display part of the hi-vision video camera, is attached to the imaging apparatus body 1000 in an openable manner. The display panel 2000 is normally accommodated in a recessed portion of the imaging apparatus body 1000, and is opened as shown in FIG. 1B in usage. The display panel 2000 can be rotated about its longitudinal direction as the axis. The display panel 2000 is provided with a liquid crystal monitor. The liquid crystal monitor displays thereon the images taken by the hi-vision video camera, and is constituted of a hi-vision screen with an aspect ratio of 16:9. The outer frame of the liquid crystal monitor of the display panel 2000 has a jog dial 2100, a menu button 2101, and a multifunction button 2103.

The jog dial 2100 is operated to select various functions and is constituted of a rotatable dial, for example. The menu button 2101 is operated to display various menus on the liquid crystal monitor. The multifunction button 2103 includes a cross-key function and can realize the operation of selection of the various functions. The multifunction button 2103 can be pressed in the up and down directions and the left and right directions, for example. In addition, the multifunction button 2103 includes an OK button function for confirming the operation of selection of the various functions, and is provided at the center of the cross key. Note that the menu button 2101, the jog dial 2100 and the multifunction button 2103 are provided close to each other, whereby the OK button can be easily operated after the jog dial 2100 has been operated. The imaging apparatus body 1000 is held stably by the right hand, the frame of the display panel 2000 is held by the left hand, and the menu button 2101, the jog dial 2100 and the multifunction button 2103 can be arbitrarily selected to be operated by the left thumb, whereby excellent operability can be provided.

The lens part 4000 is used for taking images, and has an imaging lens for receiving the light of images.

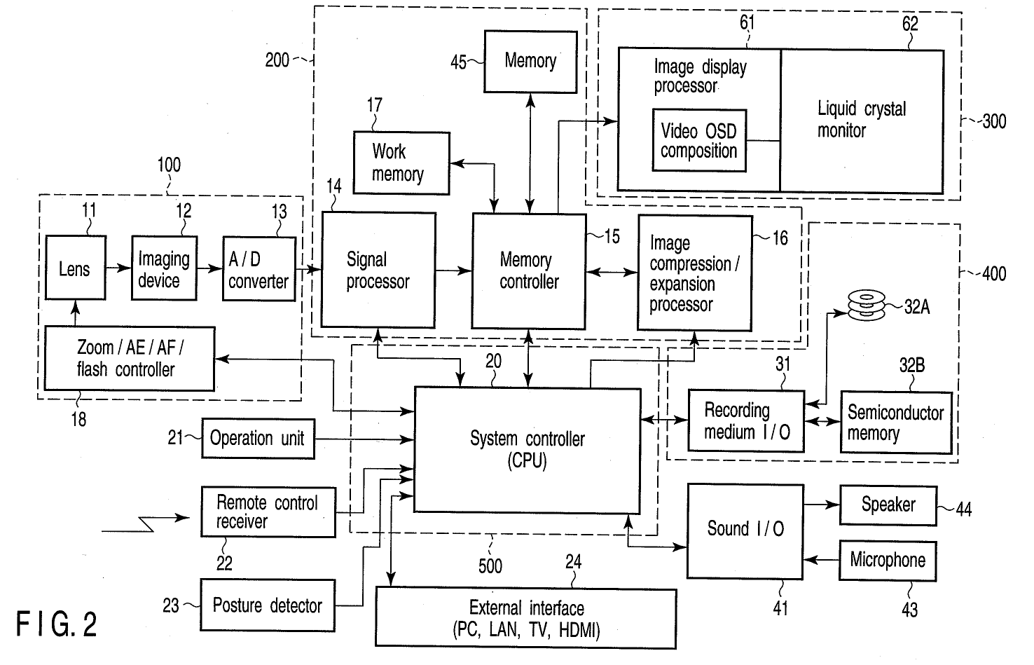

FIG. 2 is a diagram showing the optical and electrical systems of the above hi-vision video camera. The hi-vision video camera is provided with an image taking part 100, a signal processor 200, a display part 300, a storage part 400, and a controller 500.

The image taking part 100 is provided with a lens 11, an imaging device 12, an analog/digital (A/D) converter 13, and a controller 18. A subject image taken from the lens 11 is formed on an imaging surface of the imaging device 12 (for example, CCD imaging device). The subject image is converted into an electrical signal in the imaging device 12 to be converted to a digital signal (video data) by the analog/digital (A/D) converter 13, and thus to be input in the post stage of the signal processor 14. The controller 18 in an imaging part can perform zoom adjustment, automatic iris adjustment (AE), automatic focus adjustment (AF), flash control, and the like, in response to a control signal from the controller 500.

The signal processor 200 is provided with a signal processor 14, a memory controller 15, image compression/expansion processor 16, a work memory 17, and a memory 45. The signal processor 14 performs gamma correction, color signal separation, white balance adjustment, and the like, in response to the digital signal of the subject image from the image taking part 100. When a photographing start operation is not performed in a normal photographing state, the video data from the signal processor 14 is input into an image display processor 61 through the memory controller 15. When the photographing start operation is performed, the video data is subjected to image compression (for example, compression by JPEG method) in the image compression/expansion processor 16, to be stored in the storage part 400.

The work memory 17 is used, for example, when the image data is edited, a thumbnail image is created, and the order of images is changed. The work memory 17 is further used for editing various icons. The work memory 17 can store the image data of one or a plurality of screens. The video data stored in the work memory 17 is input into the image display processor 61 through the memory controller 15.

A display part 300 is provided with the image display processor 61 and a liquid crystal monitor 62. The image display processor 61 performs conversion processing for displaying the received video data on the liquid crystal monitor 62, and performs composition of video and OSD for synthesizing various display parts (for example, icons) such as menus, and supplies the video data to the liquid crystal monitor 62. The liquid crystal monitor 62 sequentially displays the received video data. Thereby, the image being imaged or the subject image desired to be imaged in a standby state is displayed on the liquid crystal monitor 62.

The storage part 400 is provided with a storage medium input/output (I/O) 31. A hard disk (HD) 32A or a storage medium such as a semiconductor memory 32B is mounted in the storage medium I/O 31. The video data is stored in the storage medium mounted in the storage medium I/O 31, on the basis of the control by the controller 500. When the video data stored in the storage medium, which is mounted in the storage medium I/O 31, is read out on the basis of the control by the controller 500, the video data is processed to be expanded in the image compression/expansion processor 16, and input into the image display processor 61 through the memory controller 15. Namely, the reproduction image is displayed on the liquid crystal monitor 62. Note that as a recording medium, an optical disk (DVD), for example, may be used in addition to the above mentioned one.

The controller 500 is provided with a system controller 20. The system controller 20 controls the overall operation of the hi-vision video camera, and is constituted of a CPU, a buffer memory such as a RAM functioning as a work area of the CPU, and a program memory such as a ROM in which various programs to be performed by the CPU and control data are stored. In the system controller 20, the CPU performs the programs stored in the program memory to realize various functions.

The hi-vision video camera is provided with an operation unit 21, a remote control receiver 22, a posture detector 23, an external interface 24, a sound I/O 41, a microphone 43, and a speaker 44.

The operation unit 21 is used for receiving the operation input from the outside, and is a generic name of the various buttons shown in FIG. 1 or a switch. The remote control receiver 22 is used for receiving the operation input by an external remote controller (not shown). The controller 500 controls the operation inputs received from the operation unit 21 and the remote control receiver 22 so as to reflect the operation inputs to the entire apparatus.

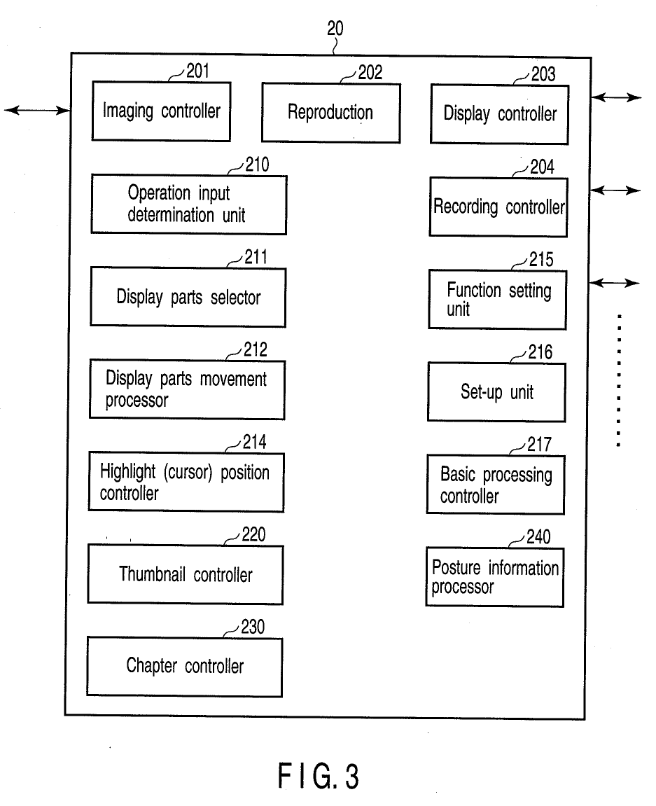

FIG. 3 shows the functions of the system controller 20. An imaging controller 201 sets the taking mode in accordance with the operation input and controls each part for the purpose of taking picked-up image data. A reproduction controller 202 sets the reproducing mode in accordance with the operation input. The display controller 203 displays image data for display sent from the signal processor 200. A recording controller 204 controls each part such that the picked-up image data is compressed in the signal processor 200 to be recorded in a selected recording medium. An operation input determination unit 210 analyzes and determines an operation signal input from the operation unit 21 or the remote control receiver 22.

A display parts selector 211 selects an arbitrary display part (such as an icon and a mark) to be displayed on a menu screen or the like. The various display parts are stored in a memory or the image display processor 61.

A display parts movement processor 212 controls the movement and deletion of the display part in response to the operation input. A highlight (cursor) position controller 214 controls a display position of a highlight position (cursor position) in response to the operation input. A function setting unit 215 sets various functions in the imaging apparatus in cooperation with a set-up unit 216. A basic processing controller 217 controls basic operation functions such as data transferring, reading, timing setting, and the like. A thumbnail controller 220 controls creation of a thumbnail, display output, scrolling, and the like. A chapter controller 230 has a chapter management function. The chapter controller 230 generates a chapter, sets a representative image of the chapter, and creates a small image of the representative image. A posture information processor 240 processes information from the posture detector 23 to display a reference image as a horizontal reference on a screen, or to change the density of the reference image in accordance with the inclined state.

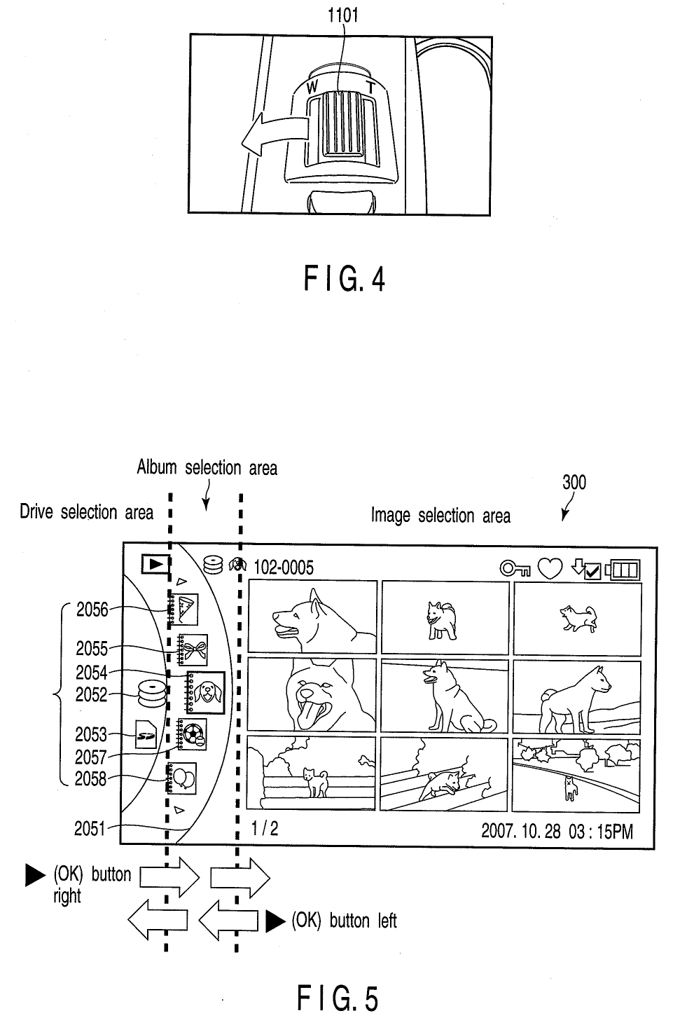

FIG. 4 shows an enlarged part of the zoom lever 1101. When the zoom lever 1101 is pressed on the left side (W side) in the reproducing mode, a thumbnail and a hierarchical display (list display) can be obtained.

FIG. 5 shows a state of a screen of the display part 300 when transferring to the list display. This screen is obtained by the controller 500 controlling each part in response to the operation input. The display parts selector 211 displays a curved band-like image 2051, which is a part of a ring shape, in a left side region of the screen of the display part 300, and, at the same time, displays a plurality of storage media mark images 2052 (for example, hard disk) and 2053 (for example, memory card) in an inside region on the left side of the curved band-like image 2051. A plurality of folder icon images 2054, 2055, 2056, 2057 and 2058 are arranged and simultaneously displayed on the curved band-like image 2051. These folder icon images represent a plurality of folders contained in the storage medium, which is designated by selecting the storage media mark images 2052 and 2053.

The thumbnail controller 220 displays a plurality of thumbnails in the folder represented by the folder icon image 2054, which is positioned at the center position among the above folder icon images, in an outside region on the right side of the curved band-like image 2051.

As described above, in the list display, the screen of the display part 300 is divided into a drive selection area, an album selection area, and an image selection area from the left.

In response to the operation input from the multifunction button for example, the cursor is controlled to be moved to an arbitrary position, which is any position, including any position of the plurality of thumbnails, a position of the center folder icon image 2054 among the plurality of folder icon images, and any position of the plurality of storage media mark images, whereby the selection state can be obtained.

The cursor appears in such a form as a highlight display surrounding the outer periphery of the thumbnail, a highlight display surrounding the outer periphery of the folder icon image, or a highlight display of the storage media mark image.

As the storage media, there are combinations of a memory card, a hard disk, a DVD, an HD DVD, and a Blu-ray disk.

When the cursor is moved onto the storage media mark image 2052 representing a hard disk to press the multifunction button, the folder icon image stored in the hard disk is arranged and displayed on the curved band-like image 2051. Meanwhile, for example, nine thumbnails in the folder corresponding to the center folder icon image 2054 are displayed.

The cursor position controller 214 is activated by pressing the left or right side of the multifunction button, whereby the cursor can be freely moved to any area of the drive selection area, the album selection area, and the image selection area.

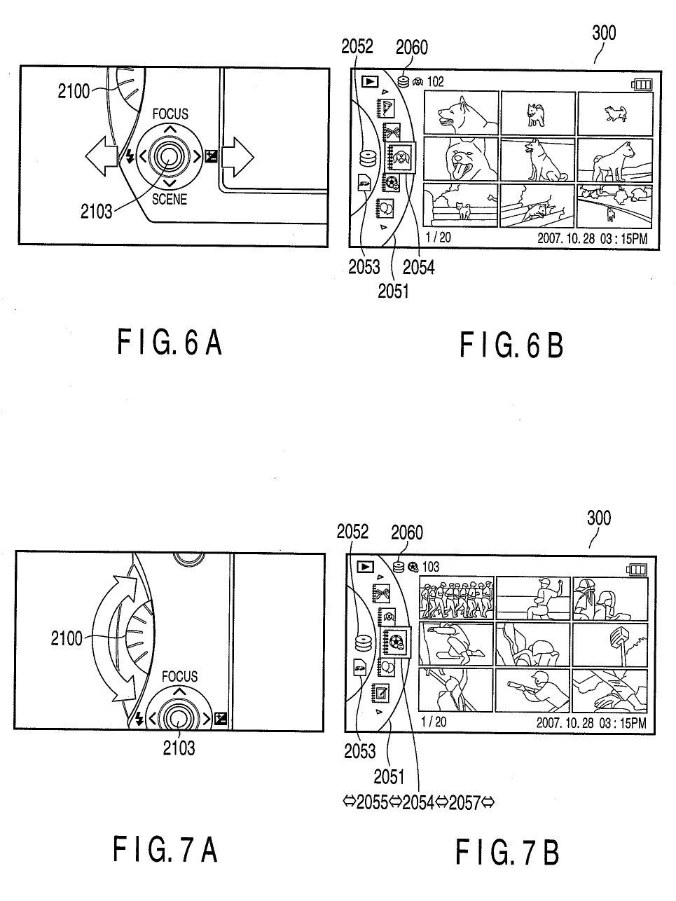

As shown in FIGS. 6A and 6B, the cursor is moved to the album selection area by operating the multifunction button. The cursor designates the center folder icon image 2054 among the arranged center folder icon images 2054, 2055, 2056, 2057 and 2058. The thumbnail in the folder corresponding to the folder icon image 2054 is then displayed. In addition, the storage media mark image 2052 representing the storage medium, which contains the relevant folder (in this example, the icon 2052 is designated) is highlighted, and, at the same time, the storage media mark image is displayed also in the upper part of the display part 300 (see, 2060).

When a user wants to confirm a thumbnail in another folder, the jog dial 2100 is rotated. Thereby, as shown in FIGS. 7A and 7B, an arbitrary one of the folder icon images 2054, 2055, 2056, 2057 and 2058, which are arranged on the curved band-like image 2051, can be moved at the center position with the aid of the display parts movement processor 212. The thumbnail in the folder, which corresponds to the folder icon image at the center position, is then displayed. Such an operation gives the user a sense of operation in which the folder icon images 2054, 2055, 2056, 2057 and 2058 arranged on the curved band-like image 2051 are rotated in response to the rotation of the jog dial. Namely, the images of the folder icon images can be visually recognized as if it is like the movement of the jog dial which is really operated by the user.

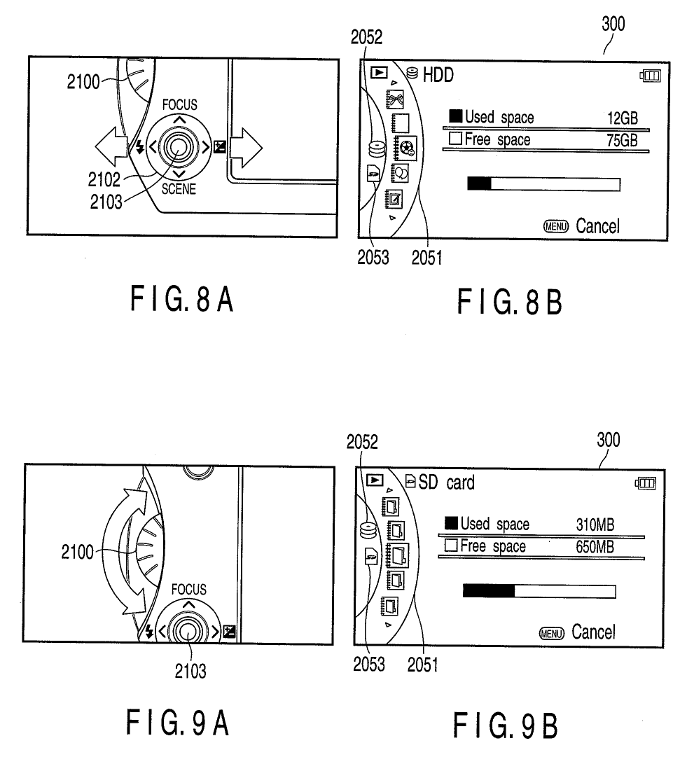

Next, a display state in which the cursor is moved to the drive selection area is described. In FIGS. 8A and 8B, the storage media mark image 2052 representing a hard disk is selected and designated by the cursor. The information showing the free space and used space of the designated storage medium is displayed by the display parts selector 211, instead of the display of the plurality of thumbnails. FIGS. 9A and 9B show a display state in which the storage media mark image 2053 representing a memory card is selected and designated.

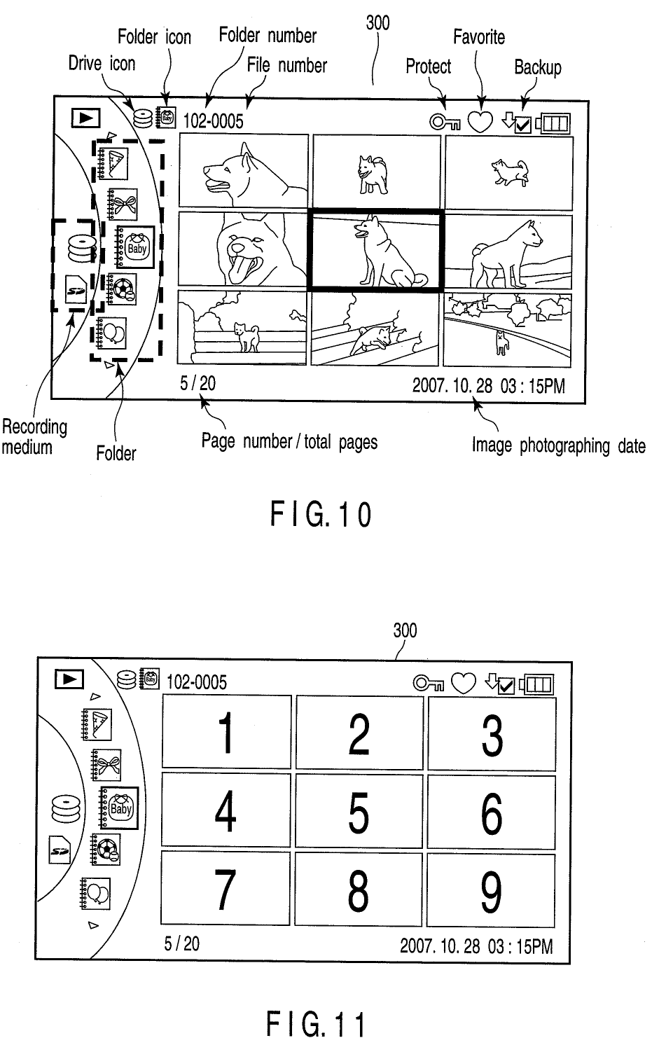

The various information being further displayed in the display part 300 are shown in FIG. 10. The presently selected folder icon image is displayed next to the selected drive icon image. The folder number and the file number can also be displayed. When the cursor is moved onto the thumbnail, the information showing the photographing date and page number/total pages is also displayed (in the example, the fifth page is displayed from among twenty pages).

FIG. 11 is a view for explaining an example of the movement of the cursor in a state that a plurality of thumbnails are displayed. When the cursor is positioned on “1”, the right key of the multifunction button is pressed, whereby the cursor is moved to 1→2→3. Likewise, when the cursor is positioned on “4”, the right key is pressed, whereby the cursor is moved to 4→5→6. When the cursor is positioned on “7”, the right key is pressed, whereby the cursor is moved to 7→8→9.

When the cursor is positioned on “3”, the left key of the multifunction button is pressed, whereby the cursor is moved to 3→2→1→the folder. In addition to the movement among the thumbnails, the cursor can be hierarchically moved from the thumbnail to the folder by the operation of the direction key. Likewise, when the cursor is positioned on “6”, the left key is pressed, whereby the cursor is moved to 6→5→4→the folder. When the cursor is positioned on “9”, the left key is pressed, whereby the cursor is moved to 9→8→7→the folder.

When the cursor is positioned on “1”, the down key of the multifunction button is pressed, whereby the cursor is moved to 1→4→7. When there are ten or more images, the down key is further pressed to move the cursor to the second page. Likewise, when the cursor is positioned on “2”, the down key is pressed, whereby the cursor is moved to 2→5→8. When the cursor is positioned on “3”, the down key is pressed, whereby the cursor is moved to 3→6→9. In both cases, if there is a second page, the cursor can be moved to the second page by further pressing of the down key.

When the cursor is positioned on “7”, the up key of the multifunction button is pressed, whereby the cursor is moved to 7→4→1. The up key is further pressed whereby the cursor is moved to the thumbnail of the prior folder. Likewise, when the cursor is positioned on “8”, the up key is pressed, whereby the cursor is moved to 8→5→2. When the cursor is positioned on “9”, the up key is pressed, whereby the cursor is moved to 9→6→3. In both cases, when the up key is further pressed, the cursor is moved to the thumbnail of the prior folder.

When the cursor has been moved to the thumbnail of the prior folder, the folder icon and the folder number displayed on the upper left of the screen and the folder icon displayed on the left side are changed with the movement of the cursor.

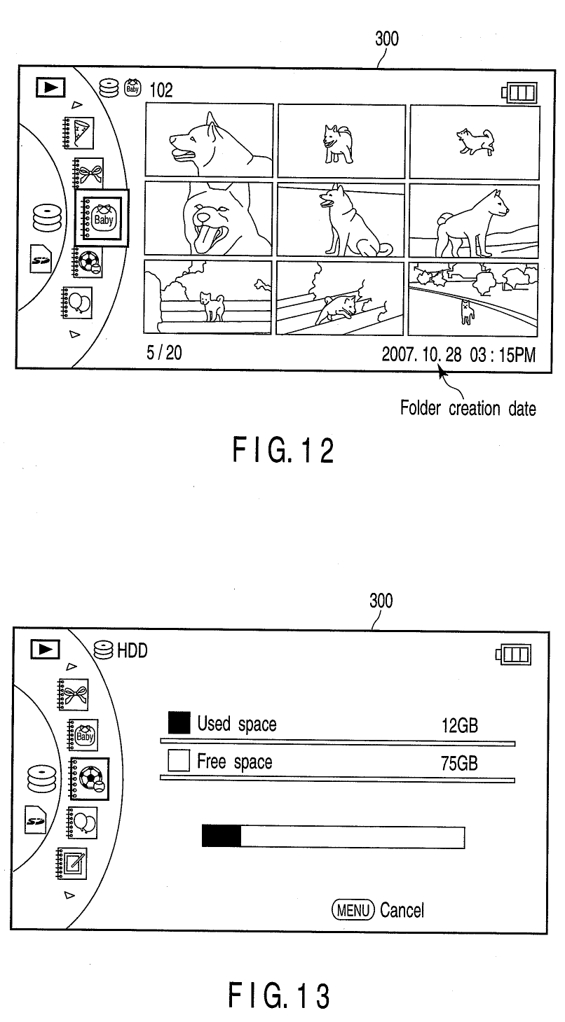

FIG. 12 is a view showing another embodiment of the hierarchical list display screen. In FIG. 12, the cursor is positioned on the folder. The date when the album was created is displayed on the lower right of the screen. At this time, the folder can be switched by pressing the up or down key. If the folder is switched, the image in the newly selected folder is displayed as the thumbnail. In addition, the folder icon and the folder number displayed on the upper left of the screen are changed with the switching of the folder. When the cursor is positioned on the folder, if the left key is pressed, the cursor is moved onto the recording medium, while if the right key is pressed, the cursor is moved onto the thumbnail.

FIG. 13 is a view showing further another embodiment of the hierarchical list display screen. In FIG. 13, the cursor is positioned on the recording medium (HDD). At this time, the information showing the used and free spaces of the recording medium is displayed on the right side of the middle part of the screen, instead of the thumbnail. The down key is pressed, whereby the recording medium can be switched from the HDD to an SD card.

This invention is not limited to the above-described embodiment as such, and the components of this invention can be modified and embodied without departing from the scope in an execution stage. Further, various inventions can be formed by appropriately combining a plurality of components disclosed in the above-described embodiment. For example, some components may be omitted from all the components shown in the embodiment. Moreover, the components relating to different embodiments may be appropriately combined.

Additionally, in the above description, although the means for giving the operation input has the multifunction button provided on the left side of the display panel 2000, the imaging apparatus of this invention can be connected with a digital television receiving apparatus through the external interface 24 with the use of the HDMICEC function. In this case, the digital television receiving apparatus works as a monitor. Further, a cross key of a remote controller for operating the relevant digital television receiving apparatus and an OK button are used, whereby it is possible to perform the same operation with the multifunction button on the left side of the display panel 2000.

Further, this invention can be applied to a control method and a program for executing this control method, and further, can be applied to a storage medium in which this program is stored.

Namely, the imaging apparatus of this invention has an image data processor for processing obtained image data which has been obtained in an image taking part, a display part for displaying image data for display which has been processed in the image data processor, a storage part for storing image data for storage which has been processed in the image data processor, an operation input part for giving an operation input, and a controller for controlling the image taking part, the image data processor, the display part, and the storage part, in response to the operation input from the operation input part.

Based on the control performed by the controller, a curved band-like image, which is a part of a ring shape, is displayed in a left side region of the display part, a plurality of storage media mark images are displayed in an inside region on a left side of the curved band-like image, and a plurality of folder icon images representing a plurality of folders, which are contained in a storage medium designated by selecting the plurality of storage media mark images, can be arranged and simultaneously displayed on the curved band-like image. Further, a plurality of thumbnails in a folder, which is positioned at a center position among the plurality of folder icon images, are displayed in an outside region on the right side of the curved band-like image. In response to the operation input, the cursor is controlled to be moved to an arbitrary position, which is any position including any position of the plurality of thumbnails, a position of the center folder icon image among the plurality of folder icon images, and any position of the plurality of storage media mark images, whereby the selection state can be obtained.

Meanwhile, the storage media mark representing a storage medium, which contains data of the plurality of thumbnails and folders represented by the plurality of folder icon images, can be highlight displayed, while other storage media images can be displayed with a suppressed brightness. Furthermore, a program for executing a method for controlling the imaging apparatus and a memory with a program stored therein are provided.

While certain embodiments of the inventions have been described, these embodiments have been presented by way of example only, and are not intended to limit the scope of the inventions. Indeed, the novel methods and systems described herein may be embodied in a variety of forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

The various module or controller of the systems described herein can be implemented as software applications, hardware and/or software modules, or components on one of more computers, such as servers. While the various modules are illustrated separately, they may share some or all of the same underlying logic or code.

What is claimed is:

1. An imaging apparatus comprising:
an image data processor configured to process a captured image data from an image capturing module;
a display module configured to display the image data processed by the image data processor;
a storage device configured to store the image data processed by the image data processor; and
a controller to control the image capturing module, the image data processor, the display module and the storage device,
wherein the controller comprises:
an item selector configured to display a band-like image in the display module, to display a plurality of icon images representing a plurality of storage media respectively substantially near the band-like image, and to align and display, on the band-like image, a plurality of folder icon images representing a plurality of folders contained in a storage medium currently selected;
a thumbnail controller configured to display a first folder icon image at a first position among the plurality of folder icon images, and to display a plurality of thumbnails in a folder represented by the first folder icon image in a first region on a first side of the band-like image; and
a cursor position controller configured to move a cursor to any position among the plurality of thumbnails, the first folder icon image, and the plurality of storage media icon images, in response to an operation input in order to obtain a state selected by a user.

2. The imaging apparatus of claim 1, wherein the item selector is configured to display the band-like image, a part of a ring shape, in a first side region of the display module, to display the plurality of storage media icon images in a first region on the first side of the band-like image, and to align and simultaneously display, on the band-like image, the plurality of folder icon images representing a plurality of folders contained in a storage medium currently selected, and
the thumbnail controller is configured to display the plurality of thumbnails in the folder represented by the first folder icon image in a first region on a second side of the band-like image.

3. The imaging apparatus of claim 1, wherein a first storage media icon image representing the storage medium comprising data of the plurality of thumbnails and folders of the plurality of folder icon images is highlighted, while the brightness of second storage media icon image is suppressed.

4. The imaging apparatus of claim 1, wherein the display module comprises a display panel and a jog dial for receiving the operation input is provided at a first side of the display panel, and
the controller comprises an icon image movement processor which is configured to rotate and move the plurality of folder icon images aligned on the band-like image when the jog dial is rotated.

5. The imaging apparatus of claim 1, wherein the item selector is configured to display information of used and free spaces of a storage medium when the cursor addresses a storage media icon image corresponding to the storage medium.

6. The imaging apparatus of claim 4, wherein the storage media icon image is a icon image for representing either a memory card, a hard disk, a DVD, an HD DVD or a Blu-ray disk.

7. The imaging apparatus of claim 1, wherein the cursor position controller is configured to move the cursor to any position among the plurality of thumbnails, the first folder icon image, and the plurality of storage media icon images, in response to the operation input from a multifunction button.

8. A method for controlling an imaging apparatus, the method comprising:
processing an image data obtained in an image capturing module;
displaying the image data;
storing the image data processed in the image data processor;
accepting an operation input from a user;
controlling the image capturing, the image data processing, the displaying, and the storing in response to the operation input;
displaying a band-like image in a display;
displaying a plurality of storage media icon images substantially near the band-like image;
aligning and displaying, on the band-like image, a plurality of folder icon images representing a plurality of folders contained in a storage medium currently selected;
displaying, in the vicinity of the band-like image, a plurality of thumbnails in a folder represented by a folder icon image at a first position;
moving a cursor to any position among the plurality of thumbnails, the first folder icon image among the plurality of folder icon images, and the plurality of storage media icon images, in response to the operation input in order to obtain a state selected by a user.

9. The method for controlling the imaging apparatus of claim 8, further comprising:
highlighting a first storage media icon image representing a storage medium containing data of the plurality of thumbnails and folders represented by the plurality of folder icon images, and
displaying a second storage media image with a suppressed brightness.
